(19) United States
(12) Patent Application Publication
(10) Pub. No.: US 2015/0018984 A1
(43) Pub. Date: Jan. 15, 2015

(54) MONITORING INTERFACE

(71) Applicant: General Electric Company, Schenectady, NY (US)

(72) Inventors: Scott Terrell Williams, Minden, NV (US); Kenneth Paul Ceglia, Gardnerville, NV (US)

(21) Appl. No.: 13/939,883

(22) Filed: Jul. 11, 2013

(51) Int. Cl. G05B 15/02

(52) U.S. Cl. CPC G05B 15/02
USPC 700/83

(57) ABSTRACT

A device receives diagnostic data related to the operation of a machine. The device is configured to receive a first user input related to a manner in which the diagnostic data is to be displayed on a display. The device is further configured to receive a second user input related to which portion of the diagnostic data is to be displayed on the display. The device is configured to transmit a signal related to the manner in which the diagnostic data is to be displayed on the display and which portion of the diagnostic data is to be displayed on the display.

### BACKGROUND

The subject matter disclosed herein generally relates to process control systems and, more specifically, to monitoring the operation of machinery.

Control systems are often used in conjunction with process systems, such as manufacturing or production processes, to regulate and/or monitor various operating parameters of the process. For instance, a control system may regulate the values of certain input parameters of the process in order to drive one or more target output parameters (e.g., flow rate, power output, etc.) to a desired value. Some control systems may also provide process data to an operator in the form of visual feedback, such as by outputting certain selected data points to a human-machine interface (HMI), which may include a graphical user interface displayed using a display device. This may enable the operator to monitor and assess the process performance parameters in substantially real time and, if necessary, take corrective actions if certain parameters are deviating from an expected range or norm.

Such control systems may use process controllers for controlling system operations, and the process controllers may include a combination of hardware and software components. As may be appreciated, these control systems may become overly complex as additional elements and measurements are implemented to be controlled. Similarly, the monitoring systems utilized to monitor the control systems may also increase in complexity. That is, these monitoring systems may provide large amounts of data that can be difficult for a user to interpret. Accordingly, it would be beneficial to streamline the monitoring system to allow for robust monitoring while simplifying the user experience.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a device to receive diagnostic data related to the operation of a machine, receive a first user input related to a manner in which the diagnostic data is to be displayed on a display, receive a second user input related to which portion of the diagnostic data is to be displayed on the display, and transmit a signal related to the manner in which the diagnostic data is to be displayed on the display and which portion of the diagnostic data is to be displayed on the display.

In a second embodiment, an article of manufacture includes a tangible machine-readable media having encoded thereon processor-executable instructions including instructions to receive an indication of a first user input related to a manner in which diagnostic data related to a machine is to be displayed on a display, instructions to receive an indication of a second user input related to which portion of the diagnostic data is to be displayed on the display, and instructions to transmit a signal related to the manner in which the diagnostic data is to be displayed on the display and which portion of the diagnostic data is to be displayed on the display.

In a third embodiment, a tangible machine-readable media comprising code to determine, based on a received indication of a first user input, a manner in which diagnostic data related to a machine is to be displayed on a display, determine, based on a received indication of a second user input, which portion of the diagnostic data is to be displayed on the display, and generate a signal for transmission, wherein the signal is related to the manner in which the diagnostic data is to be displayed on the display and which portion of the diagnostic data is to be displayed on the display.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram view of an embodiment including an industrial control system, in accordance with an embodiment;

FIG. 2 is a block diagram of human machine interface of FIG. 1, in accordance with an embodiment;

FIG. 3 is a first screenshot of a GUI used in conjunction with the human machine interface of FIG. 1, in accordance with an embodiment;

FIG. 4 is a second screenshot of a GUI used in conjunction with the human machine interface of FIG. 1, in accordance with an embodiment;

FIG. 5 is a third screenshot of a GUI used in conjunction with the human machine interface of FIG. 1, in accordance with an embodiment;

FIG. 6 is a fourth screenshot of a GUI used in conjunction with the human machine interface of FIG. 1, in accordance with an embodiment;

FIG. 7 is a fifth screenshot of a GUI used in conjunction with the human machine interface of FIG. 1, in accordance with an embodiment; and

FIG. 8 is a sixth screenshot of a GUI used in conjunction with the human machine interface of FIG. 1, in accordance with an embodiment.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Further, the term “client” may refer to a computer (e.g., a processor and storage that allows execution and storage of machine-readable instructions to provide the functionality described herein) and/or computer processes running on such computers.

Present embodiments relate to systems and methods for monitoring components or machinery in one or more industrial systems. For example, a monitoring system may be present that generates data for use by a user in monitoring, for example, industrial machinery. In some embodiments, this data may be historical data, for example, stored in a server. In other embodiments, this data may be real time observed data received from one or more field locations that include the machinery. The monitoring system may filter this data, for example, based on user configuration decisions that allow for desired data to be present on a display. These user configurations may allow for a user to set up or configure the monitoring system to display desired data as part of a common GUI with the display of the data. This configuration may also include selection of preset choices available to the user to aid in deciding which data to make available for viewing. By including the configuration ability in a common GUI with the monitoring (e.g. diagnostic) GUI, the overall flexibility and ease with which a user may utilize the monitoring system may be increased.

Additionally, as part of the GUI of the monitoring system, a view selection tab may be included. This view selection tab may allow for automatic (e.g., monitoring system based) switching between data sets to be presented to a user. In this manner, a single interface may be utilized to provide accessibility to a large set of distinct and separate data pools (each, for example, corresponding to particular machinery). Moreover, setup of this monitoring system may be part of the common GUI to allow for streamlined set up of the monitoring system to provide desired data for monitoring. In this manner, distinct machinery may be monitored in a single GUI as part of the monitoring system. Additional capabilities may also be added to the monitoring system via plug-in software programs that, for example, may be machine specific and included as desired by a user. This allows for greater flexibility of the monitoring system.

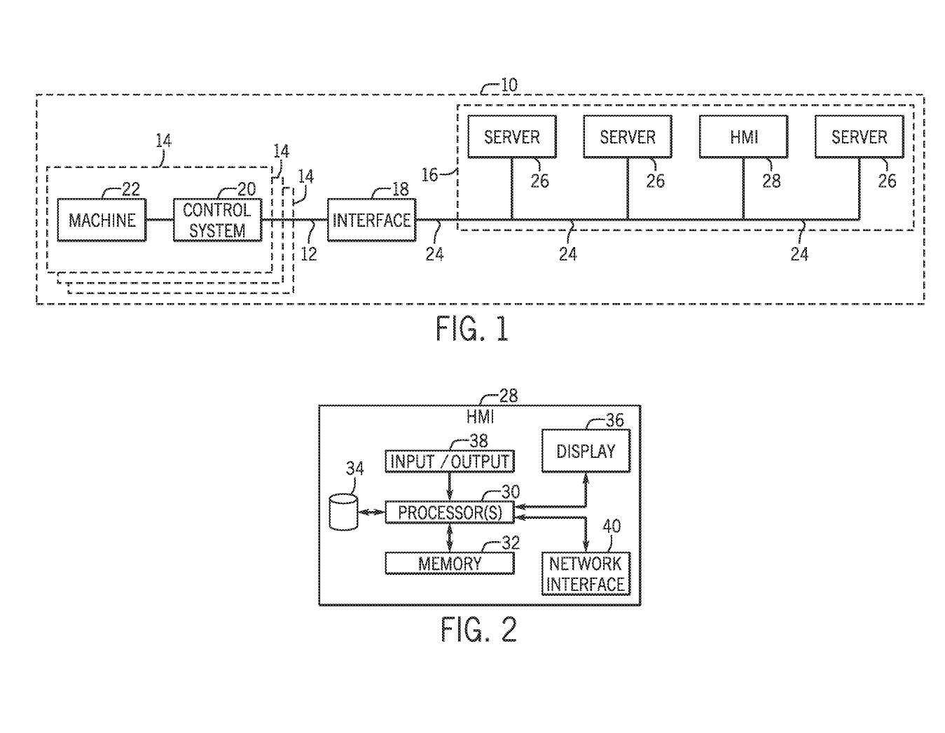

With the foregoing in mind, FIG. 1 illustrates a block diagram view of an industrial control system (“ICS”) 10. The ICS may include, for example, a network path 12 that couples one or more field locations 14, to a control system network 16, via, for example, a communication interface 18. The field locations 14 may include a control system 20 as well as machinery 22 to be monitored. In some embodiments, the control system 20 may monitor one or more operating parameters of the machinery 22. In certain embodiments, the machinery 22 may be representative of one or more of the following: wind turbines, steam turbines, hydraulic turbines, gas turbines, aeroderivative turbines, compressors, gears, turbo-expanders, pumps, motors, generators, fans, blowers, agitators, mixers, centrifuges, pulp refiners, ball mills, crushers/pulverizers, extruders, pelletizers, cooling towers/heat exchanger fans, and/or other systems suitable to be monitored.

During operation of the machinery 22, one or more sensors may measure one or more operating parameters of the machinery 22 and transmit the measured values as signals to the control system. The sensors may be transducers or other suitable measurement devices, which can be used to measure various parameters of the machinery 22 or components therein, for example, the rotational speed of a shaft of a turbine, the operating temperature of a turbine, or other similar operating parameters. The sensors may transmit the signals related to the operating parameter of machinery 22 to be monitored to control system 20.

Accordingly, in one embodiment, the control system 20 may receive one or more signals indicative of measured operating parameters of the machinery 22 and may record and/or analyze the signal indicative of measured operating parameters of the machinery 22, for example, to generate control signals used to adjust input values for the machinery 22 (e.g., to control the operation of the machinery 22).

In some embodiments, the control system 20 may transmit information related to the operation of the machinery 22 to interface 18 along signal path 12, which may be a physical connection or a wireless connection. Interface 18 may be a router or other network device that transmits communication signals. Additionally or alternatively, interface 18 may be a communication interface that alters signals transmitted between the field locations 14 and control system network 16 (e.g., converts signals from one communication protocol to another). Interface 18 may transmit signals received between field locations 14 and control system network 16 along signal path 24, which may also be a physical connection or a wireless connection. For example, each of signal paths 12 and 24 may be a wired connection, such as an Ethernet connection and/or the like. Alternatively, each of signal paths 12 and 24 may be a wireless signal path, such as a local area network (LAN) (e.g., Wi-Fi), a wide area network (WAN) (e.g., 3G or 4G), a Bluetooth network, and/or part of another wireless network. Additionally, in some embodiments, signal path 12 may be a physical connection, while signal path 24 may be a wireless connection or vice versa.

As illustrated in FIG. 1, signal path 24 may be coupled to one or more servers 26 as well as a human machine interface 28 in the control system network 16. The servers 26 may include, for example, data acquisition servers that allow for the storage and/or retrieval of field location 14 data, database servers that provide database services to other computer programs or computers, and or other various servers. Additionally, as previously set forth, the control system network 16 may include one or more human machine interfaces 28, which may, for example, include a workstation and/or computer. This workstation or computer may be utilized, for example, to display information to a user related to one or more field locations 14 to allow for monitoring and/or control of the elements present in one or more of the field locations 14. That is, human machine interface 28 may implement a monitoring system that allows for monitoring of the conditions of the machinery 22 in one or more of field locations 14.

Additionally, it may be appreciated that one or more human machine interfaces 28 may be present at each of the field locations 14 in addition to or in place of the human machine interface 28 of the control system network 16. Thus, while the human machine interface 28 of the control system network 16 may allow for monitoring of multiple field locations 14, local human machine interfaces 28 may also be present instead of or in addition to the human machine interface 28 of the control system network 16, whereby the human machine interface 28 of each field location 14 may monitor machinery 22 present in the respective field location 14 in which the local human machine interface 28 is present. An example of these human machine interfaces 28 is illustrated in FIG. 2

As illustrated in FIG. 2, the human machine interface 28 includes processor 30 and/or other data processing circuitry may be operably coupled to memory 32 and storage 34 to execute instructions for carrying out the presently disclosed techniques. These instructions may be encoded in programs that may be executed by the processor 30 and/or other data processing circuitry (e.g., general central processing units (CPUs), embedded CPUs, systems on a chip (SOC), application specific processors, application specific integrated circuits (ASICs), field programmable gate arrays (FPGAs), and their combinations) which may be operably coupled to memory 32 and to execute instructions for carrying out the presently disclosed techniques. These instructions may be encoded in programs that may be executed by the processor 30. Additionally, the instructions may be stored in any suitable article of manufacturer that includes at least one tangible, computer-readable medium that at least collectively stores these instructions or routines, such as the memory 32 or the storage 34. The memory 32 and the storage 34 may include, for example, random-access memory, read-only memory, rewritable memory, flash memory, and/or other physical storage devices, such as a hard drive and/or optical discs.

The human machine interface 28 also may include a display 36 that may display a graphical user interface (GUI) of the human machine interface 28. As should be appreciated, the human machine interface 28 may include a variety of other components, such as a power supply, a keyboard, a mouse, a track pad, and/or a touch screen interface, and so forth. By way of example, the human machine interface 28 may also include input/output (I/O) ports 38 that allow for physical components to be externally coupled to the human machine interface 28, as well as a network interface 40. The network interface 40 may provide communication via a personal area network (PAN) (e.g., Bluetooth), a local area network (LAN) (e.g., Wi-Fi), a wide area network (WAN) (e.g., 3G or LTE), Ethernet, and/or the like. Through the network interface 40, the human machine interface 28 may communicate over signal path 24 for example, to enable processing and/or communication with other networked devices, such as the servers 26 and/or control system 20.

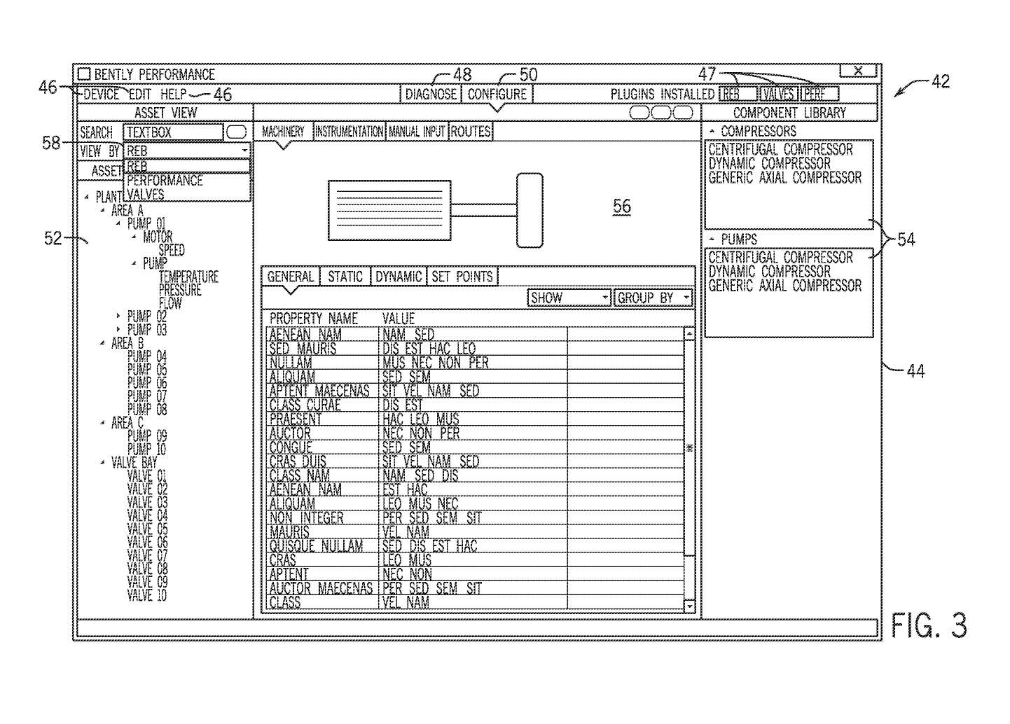

As previously noted, the human machine interfaces 28, regardless of their physical location in field location 14 or control system network 16, may implement a monitoring system that may include code (e.g., monitoring software) stored on a tangible machine readable medium (e.g., memory 32 and/or storage 34) that may enable a user to quickly identify important events, evaluate situations, and respond to the events and situations present in control system 20 and/or machinery 22. This may lead to increased equipment availability, reliability, and reduced maintenance costs. In some embodiments, the monitoring system may include real-time alteration of operational characteristics of the machinery and/or selected processes to increase performance, decrease waste, or for other reasons. The monitoring system may also perform condition monitoring and event diagnostics. Moreover, the monitoring system may allow for a graphical user interface (GUI) that allows for user interaction. In some embodiments, the monitoring system may be a System 1® condition monitoring software and diagnostics software platform made available by General Electric® of Schenectady, N.Y., or a similar system. FIG. 3 illustrates one screenshot of the GUI of the monitoring system of the human machine interface 28, as rendered on display 36.

As discussed above, FIG. 3 illustrates a GUI 42 that may be present on display 36. This GUI 42 may include screenshot 44 of items viewable by a user. Additionally, the user may interact with the GUI 42 by touching a touch screen display 36 that allows for user input to be received directly on the display screen 36. In another embodiment, a user may interact with the GUI 42 via input structures, such as buttons, sliders, switches, control pads, keys, knobs, scroll wheels, keypads, a mouse, touchpads, and so forth. These may facilitate the interaction of a user with the GUI 42.

The GUI 42 may include text and/or one or more graphical icons to allow a user to interface with the monitoring system. For example, the GUI 42 may include tabs 46 that allow a user to navigate the GUI 42. Additionally, the GUI 42 may show the type of monitoring that may occur as represented by plug-in tabs 47. These plug-in tabs 47 may represent the choices that a user has available to set up the monitoring system and, in some embodiments, may be implemented separately from the monitoring system based on, for example, the machinery 22 present to be monitored. That is, the plug-in tabs 47 may represent instructions added to the monitoring system, for example, at a date subsequent to in implementation of the monitoring system (e.g., the plug-in tabs may represent software add-ons available to a user).

The GUI 42 may also include environment selection tabs 48 and 50 that may correspond to different views that a user may select. GUI 42 may also include location information 52 that provides information to a user as to which location 14 and/or which machinery 22 is being viewed at a given time. GUI 42 may further include library information 54 that provides a user with information as to which machinery 22, and what components therein, have been integrated into the monitoring system. Also illustrated as part of the GUI 42 is a machinery screen 56 that provides information as to selected machinery 22 to a user, as well as a view selection tab 58, which provides a selectable list of views available to a user.

As illustrated in FIG. 3, the GUI 42 is split into two main environments, a configuration and a diagnostic environment, selectable by environment selection tabs 48 and 50, respectively. However, it should be noted that less or more additional environments may be utilized in conjunction with the present GUI 42. FIG. 3 illustrates a screenshot 44 view that corresponds to the configure environment selection tab 50 being selected (e.g., to allow a user to configure various monitoring outputs of the GUI 42). Additionally, while in the configuration environment, a user may select one of a plurality of tabs from the view selection tab 58. In the present embodiment, a user may select “REB”, which may correspond to a rolling element bearing (e.g., a particular element of machinery 22 to be monitored). Through interaction with the machinery screen 56, a user may set up (e.g., configure) various specific monitoring selections. This may allow for a customizable monitoring experience for a user, e.g., tailored to the demands of a particular user/ICS 10. In some embodiments, the monitoring system may itself tailor the user experience (i.e., what a user may see on display 36) based on what the user has selected in the configuration environment. For example, the monitoring system may present a set of configuration options and screens specifically for configuring REB tools from a preset stored set of options. This may allow for setting up the monitoring system without the user having to specifically program the GUI 42 or the monitoring system (i.e., it allows the monitoring system to be set up based on predetermined available options to increase the robustness of the monitoring system, while still allowing for the system to be user friendly).

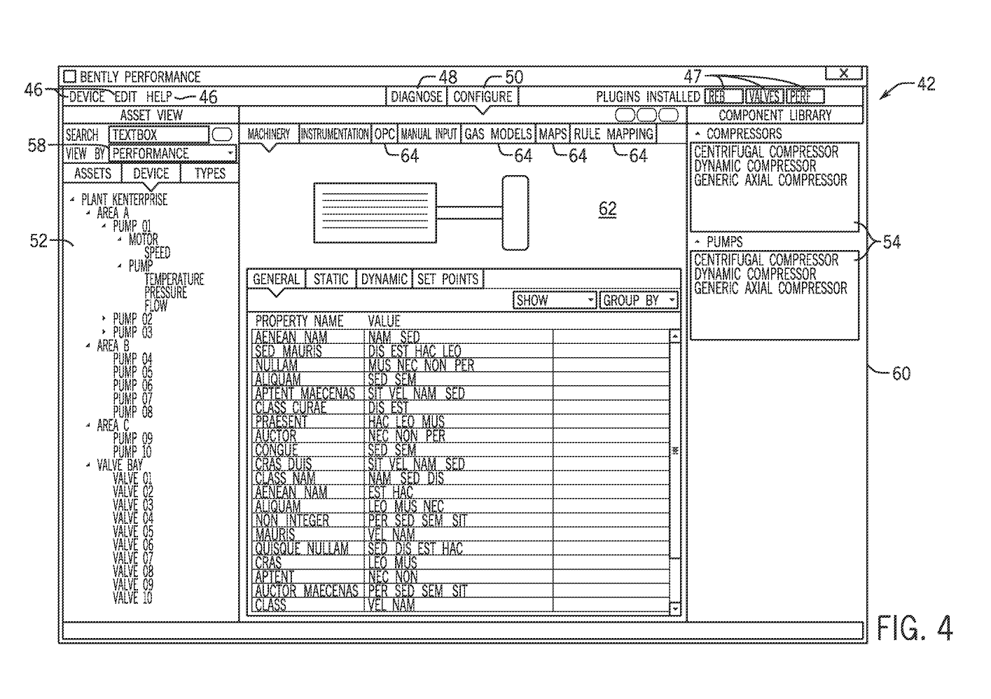

Accordingly, by utilizing a machinery screen 56 that includes particular pre-set options for configuration of monitoring of an element (e.g., the REB) through use of, for example, the view selection tab 58, the monitoring system may be user configurable while still retaining its ease of use. FIG. 4 details an additional implementation of the GUI 42 of FIG. 3.

FIG. 4 illustrates a second screenshot 60 of GUI 42 that may be present on display 36. Similar to FIG. 3 discussed above, screenshot 60 may include tabs 46, plug-in tabs 47, environment selection tabs 48 and 50, location information 52, library information 54, and a view selection tab 58. Additionally, the GUI 42 may include a machinery screen 62 that provides information as to selected machinery 22 to a user. As illustrated in screenshot 60, a configuration environment is selected by a user, corresponding to configure environment selection tab 50 being selected (e.g., to allow a user to configure various monitoring outputs of the GUI 42). Additionally, while in the configuration environment, a user may select one of a plurality of tabs (e.g., “performance”), from the view selection tab 58, which may correspond to the showing of a machinery screen 62 that includes, in this example, performance tabs 64 not present in screenshot 44. These performance tabs 64 may allow for a user to select specific performance monitoring screens and technologies to tailor the monitor system as desired. In addition, in some embodiments, library information 54 choices on the GUI 42 may be filtered as well, for example, in conjunction with specific performance only configuration choices made by a user.

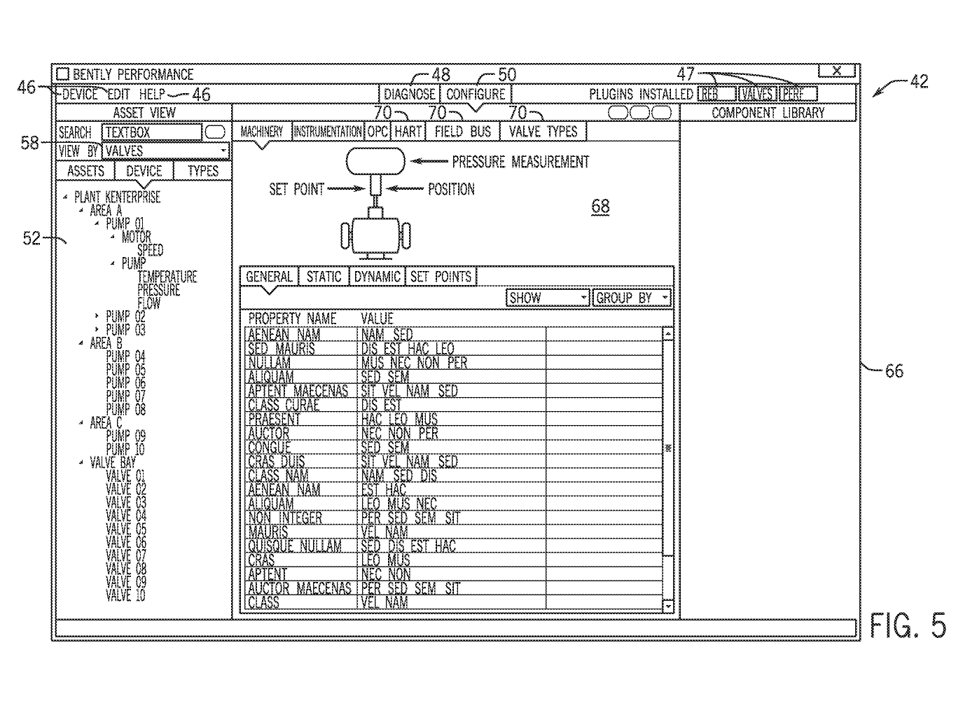

FIG. 5 illustrates a third screenshot 66 of GUI 42 that may be present on display 36. Similar to FIGS. 3 and 4 discussed above, screenshot 66 may include tabs 46, plug-in tabs 47, environment selection tabs 48 and 50, location information 52, and a view selection tab 58. Additionally, the GUI 42 may include a machinery screen 68 that provides information as to selected machinery 22 to a user. As illustrated in screenshot 66, a configuration environment is selected by a user, corresponding to configure environment selection tab 50 being selected (e.g., to allow a user to configure various monitoring outputs of the GUI 42). Additionally, while in the configuration environment, a user may select one of a plurality of tabs (e.g., “valves”), from the view selection tab 58, which may correspond to the showing of a machinery screen 68 that includes, in this example, valve tabs 70 not present in screenshots 44 and 60. These valve tabs 70 may allow for a user to select specific performance monitoring of valves of the machinery 22 to tailor the monitor system as desired. It should be noted that while valve tabs 70 are illustrated, in other embodiments, other systems or subsystems of machinery 22 may instead be selected and their corresponding machinery screens would be shown to a user to allow for tailoring of monitoring options for the selected machinery 22.

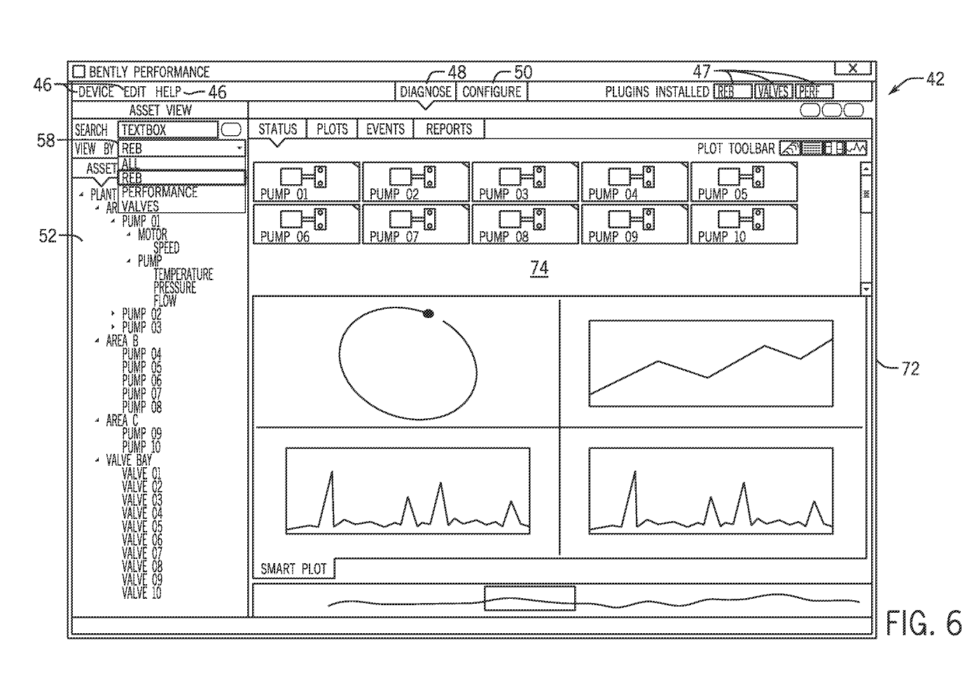

Thus, each of FIGS. 3-5 illustrate the ability of the monitoring system to allow a user to specify what type of monitoring may occur, through the use of a GUI 42. The GUI 42 also is able to show actual monitoring of the machinery 22, as will be discussed below in conjunction with FIGS. 6-8.

FIG. 6 illustrates a fourth screenshot 72 of GUI 42 that may be present on display 36. Similar to FIGS. 3, 4, and 5 discussed above, screenshot 72 may include tabs 46, plug-in tabs 47, environment selection tabs 48 and 50, location information 52, and a view selection tab 58. Additionally, the GUI 42 may include a diagnostic screen 74 that provides information as to selected machinery 22 to a user. As illustrated in screenshot 72, a diagnostic environment is selected by a user, corresponding to diagnostic environment selection tab 48 being selected (e.g., to allow a user to diagnose and/or monitor various outputs of the machinery 22).

While in the diagnostic environment, a user may select one of a plurality of tabs (e.g., “REB”), which may correspond to a rolling element bearing (e.g., a particular element of machinery 22 to be monitored), from the view selection tab 58. This may correspond to diagnostic screen 74 being shown as part of the GUI 42. For example, when the user selects a particular asset (e.g., REB) to view data for that asset, the machinery may display plots that are specific to diagnostics of that asset (e.g., rolling element bearing diagnostics).

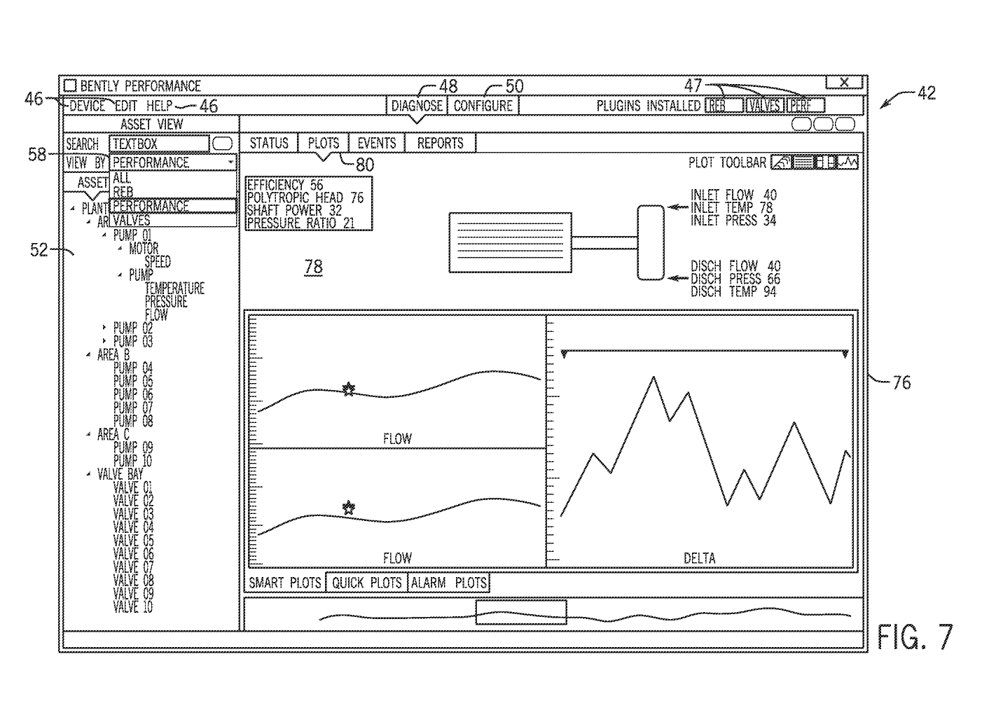

Likewise, in FIG. 7, a fifth screenshot 76 of GUI 42 is illustrated. Screenshot 76 may include tabs 46, plug-in tabs 47, environment selection tabs 48 and 50, location information 52, and a view selection tab 58. Additionally, the GUI 42 may include a diagnostic screen 78 that provides information as to selected machinery 22 to a user. As illustrated in screenshot 76, a diagnostic environment is selected by a user, corresponding to diagnostic environment selection tab 48 being selected (e.g., to allow a user to diagnose and/or monitor various outputs of the machinery 22).

While in the diagnostic environment, a user may select one of a plurality of tabs (e.g., “performance”), which may correspond to a user requesting a view that will provide performance characteristics of an asset (e.g., the REB). Additionally, by selection of view tab 80, a user may view plots and diagnostic options that are specific to looking at the performance of a selected asset. That is, the monitoring system may retrieve information related to the selections made by the user and received via the GUI 42 to provide the desired information to a user.

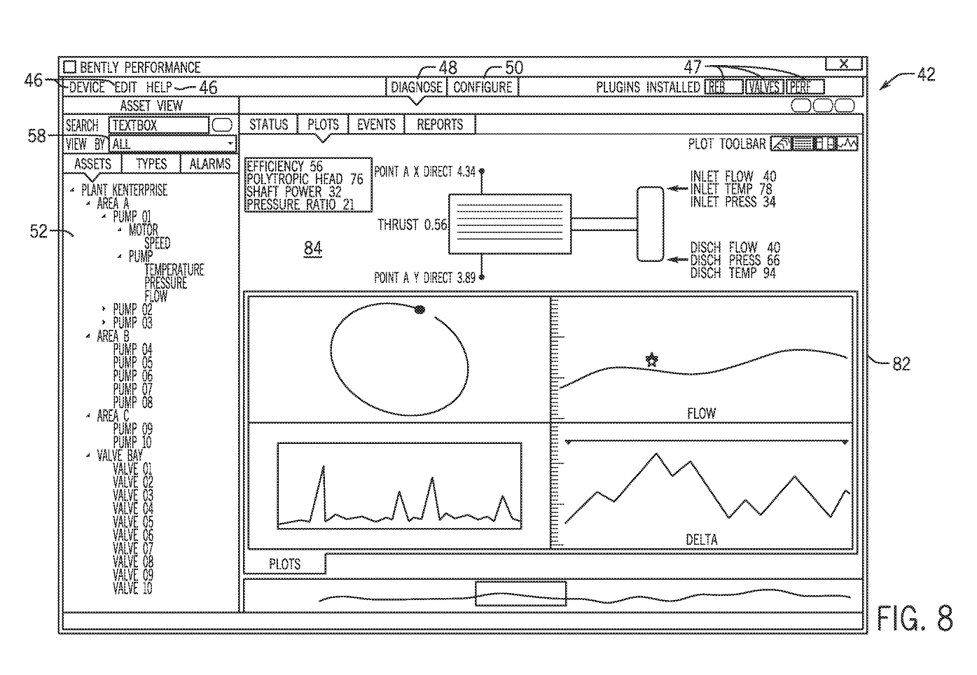

Similarly, in FIG. 8, a sixth screenshot 82 of GUI 42 is illustrated. Screenshot 82 may include tabs 46, plug-in tabs 47, environment selection tabs 48 and 50, location information 52, and a view selection tab 58. Additionally, the GUI 42 may include a diagnostic screen 84 that provides information as to selected machinery 22 to a user. As illustrated in screenshot 82, a diagnostic environment is selected by a user, corresponding to diagnostic environment selection tab 48 being selected (e.g., to allow a user to diagnose and/or monitor various outputs of the machinery 22).

While in the diagnostic environment, a user may select one of a plurality of tabs (e.g., “all”), which may correspond to a user requesting a view that will provide multiple performance characteristics of an asset simultaneously. This is represented in diagnostic screen 84. In this manner, the monitoring system may correlate data from a plurality of technologies at the same time for common representation on a single diagnostic screen 84.

For example, if a monitoring system had a plurality of monitoring capabilities (e.g., a thermal performance plug-in, a vibration plug-in, and a lubrication plug-in) related to a given asset, if the particular asset (e.g., a particular machine or element of machinery 22) was experiencing a fault (e.g., a worn bearing) the monitoring system may simultaneously render vibration levels, the lubrication metal content, and the thermal performance degradation values as part of GUI 42 to allow for a more accurate diagnosis. That is, if the user were only able to view these values separately, a probability of accurately diagnosing a problem/fault (e.g., a worn bearing fault) is reduced.

Moreover, while the monitoring system may allow for this group evaluation, in other embodiments, separate evaluations of the data requested by a user may instead be rendered. For example, in some cases, it may be advantageous to look at each type of technology separately and individually to gain a clear understanding of the data. The monitoring system may allow for such individual representations to be shown (e.g., through manipulation of view selection tab 58). Thus, for example, a thermal performance engineer might look at the performance data. Similarly, a vibration expert might separately view the bearing vibration data. This process might be repeated as often as desired when separate viewing of the data rendered via the GUI 42 is advantageous.

Additionally, it should be noted that the view selection tab 58 may not only include monitoring technologies. In some embodiments, the view selection tab 58 may correspond, for example, to modes of machine operation, such as “startup”, “shutdown,” or “steady state”. This additional flexibility offered by the monitoring system may allow for different plot and data formats for different machine modes to be presented to a user. Additionally, in some embodiments, the view selection tab 58 when encompassing the mode of the machine operation may operate in manner similar to that described above with respect to FIGS. 3-8 (e.g., a user may place the monitoring system in a specific mode tailored to the state of a given machine).

In this manner, the monitoring system may generate data for use by a user in monitoring, for example, machinery 22. In some embodiments, this data may be historical data, for example, stored in server 26, or may be real time data received from field locations 14. The monitoring system may filter this data, for example, based on user configuration decisions that allow for desired data to be present on a display 36. Moreover, by including a view selection tab 58 as part of the GUI 42 of the monitoring system, the monitoring system may automatically switch between data sets to be presented to a user. This allows for a single interface to provide accessibility to a large set of distinct and separate data pools (each, for example, corresponding to particular machinery 22). Moreover, the setup of this system may be part of the same GUI 42 and may allow for a user friendly system to set up the monitoring system to provide desired data for monitoring. Thus, distinct machinery may be monitored in a single GUI 42 as part of the monitoring system. Additional capabilities may also be added to the monitoring system via plug-in software programs that, for example, may be machine specific and included as desired by a user. This allows for greater flexibility of the monitoring system. In some embodiments, the monitoring system and/or the plug-ins may be code stored on a tangible machine readable medium, such as an optical disc, flash memory, a server (e.g., and downloaded via an internet or a local connection), or another physical storage device.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A device configured to:
receive diagnostic data related to the operation of a machine;
receive a first user input related to a manner in which the diagnostic data is to be displayed on a display;
receive a second user input related to which portion of the diagnostic data is to be displayed on the display; and
transmit a signal related to the manner in which the diagnostic data is to be displayed on the display and which portion of the diagnostic data is to be displayed on the display.

2. The device of claim 1, wherein the device is configured to receive the first user input and second user input as responses to a common graphical user interface displayed on the display when both the first user input and the second user input are received by the graphic user interface.

3. The system of claim 1, wherein the device is configured to receive the diagnostic data in real time.

4. The system of claim 1, wherein the device is configured to receive the diagnostic data from storage as historical data.

5. The system of claim 1, wherein receiving the first user input comprises identifying the first user input as corresponding to one value from a pre-set plurality of values related to the machine.

6. The system of claim 5, wherein the device is configured to receive a second pre-set plurality of values related to the machine.

7. The system of claim 6, wherein the device is configured to receive the second pre-set plurality of values related to the machine from via an internet connection.

8. The system of claim 1, wherein receiving the second user input comprises selecting the portion of the diagnostic data based in part on the first user input.

9. An article of manufacture, comprising:
a tangible machine-readable media having encoded thereon processor-executable instructions comprising:
instructions to receive an indication of a first user input related to a manner in which diagnostic data related to a machine is to be displayed on a display;
instructions to receive an indication of a second user input related to which portion of the diagnostic data is to be displayed on the display; and
instructions to transmit a signal related to the manner in which the diagnostic data is to be displayed on the display and which portion of the diagnostic data is to be displayed on the display.

10. The article of manufacture of claim 9, comprising instructions to receive the indications of the first and second user inputs as responses to a common graphical user interface displayed on the display when both the first user input and the second user input are received.

11. The article of manufacture of claim 9, comprising instructions to identify the indication of the first user input as corresponding to one value from a pre-set plurality of values related to the machine.

12. The article of manufacture of claim 11, comprising instructions to receive a second pre-set plurality of values related to the machine.

13. The article of manufacture of claim 9, comprising instructions to select the portion of the diagnostic data based in part on the indication of the first user input.

14. The article of manufacture of claim 13, comprising instructions to transmit the signal as inclusive of measurements of disparate operational characteristics of the machine.

15. A tangible machine-readable media comprising code configured to:
determine, based on a received indication of a first user input, a manner in which diagnostic data related to a machine is to be displayed on a display;
determine, based on a received indication of a second user input, which portion of the diagnostic data is to be displayed on the display; and
generate a signal for transmission, wherein the signal is related to the manner in which the diagnostic data is to be displayed on the display and which portion of the diagnostic data is to be displayed on the display.

16. The tangible machine-readable media of claim 15, comprising code configured to generate a graphical user interface for display on the display when both the first user input and the second user input are received.

17. The tangible machine-readable media of claim 15, comprising code configured to identify the indication of the first user input as corresponding to one value from a pre-set plurality of values related to the machine.

18. The tangible machine-readable media of claim 17, comprising code configured to receive an indication of a second pre-set plurality of values related to the machine.

19. The tangible machine-readable media of claim 15, comprising code configured to select the portion of the diagnostic data based in part on the indication of the first user input.

20. The tangible machine-readable media of claim 15, comprising code configured to generate the signal as inclusive of measurements of disparate operational characteristics of the machine.
